(19) United States
(12) Patent Application Publication
(10) Pub. No.: US 2006/0254240 A1
(43) Pub. Date: Nov. 16, 2006

(54) Self-Propelled Agricultural Harvester

(75) Inventors: Bernard Krone, Spelle (DE); Josef Horstmann, Ibbenburen (DE); Bernward Overmeyer, Mettingen (DE); Markus Ester, Lunne (DE)

Correspondence Address: GUDRUN E. HUCKETT DRAUDT, LONSSTR. 53, WUPPERTAL, 42289, DE

(73) Assignee: MASCHINENFABRIK BERNARD KRONE GMBH, Spelle (DE)

(21) Appl. No.: 11/307,169

(22) Filed: Jan. 26, 2006

(30) Foreign Application Priority Data
Jan. 27, 2005 (DE) 102005004004.7

(51) Int. Cl. A01D 61/00

(52) U.S. Cl. 56/16.6

(57) ABSTRACT

A self-propelled agricultural harvester has a harvesting device arranged in a traveling and working direction of the harvester in front of a driver's cab. The harvesting device extends with its length in a transverse direction transverse to the traveling and working direction. The harvesting device has mowing and conveying devices that are driven in circulation about essentially vertical axes. Each side of the harvester has at least two of the mowing and conveying devices positioned adjacent to one another in the transverse direction. The devices cut, pick up, and convey as an endless conveyor an upright crop. The crop is fed to an intake area of the harvester exclusively with an area of the mowing and conveying device facing the upright crop. The mowing and conveying devices of each side of the harvester are driven in the same direction, respectively.

### BACKGROUND OF THE INVENTION

The invention relates to a self-propelled agricultural harvester comprising a harvesting device in the form of a mowing and conveying implement or the like that is arranged preferably in the area in front of a driver's cab, is comprised of at least two parts, and extends in its longest extension transversely to the traveling and working direction of the harvester and comprises mowing and conveying means that are circulatingly driven about essentially vertical axes. At least two of the mowing and conveying means are arranged adjacent to one another on each harvester side in a direction transverse to the traveling and working direction; they cut and pick up the crop and convey the crop like an endless conveyor. In particular by its design and flexibility, the harvesting device significantly increases the efficiency of the harvester.

Harvesters of the aforementioned kind are available in numerous embodiments; preferably, they are field choppers with a harvesting attachment or implement for harvesting a stalky crop such as corn or the like.

Efficiency and speed are requirements that are to be improved upon continuously. Wider and wider working widths of the attachments or implements that are made possible by greater and greater motor output of the harvesters and that increase the efficiency of the harvester accordingly, require however increasingly complex solutions with regard to handling and transport.

In order to prevent for road transportation of harvesters with harvesting devices of great working width a particularly time-consuming demounting of the harvesting device and transport of the detached harvesting device on a separate transportation vehicle, different configurations of harvesting devices that provide a width reduction in a transport position are already known. In order to observe the legal regulations for driving a harvester on roads, not only a maximum width of, for example, 3 meters, must be observed but also a permissible maximum transport height and a permissible maximum limitation of the field of view of the driver, as well as a maximum axle load. Moreover, the most important criteria for a stable and comfortable driving behavior and thus for traffic safety include weight distribution as uniformly as possible and a center of gravity as low as possible.

However, this is counteracted by increasingly greater weights of the attachments with increasing working width. Special embodiments of harvesting devices that operate with a plurality of rotatingly driven drums as cutting and pick-up elements and generally rely on additional conveying elements for crop transport become increasingly more complex and heavy with increasing working width and thus also very expensive with regard to their manufacture as well as with regard to future maintenance relating to service and replacement parts.

EP 1 008 291 A1 should be mentioned as an example in this connection; the figures illustrate very well the aforementioned disadvantages of such a configuration.

FIGS. 2, 3, and 5 of EP 1 008 291 A1 also illustrate very well that the spacing of the front end (cutting and pick-up plane) of the harvesting device from the intake area of the harvester is very large because of the crop conveying action taking place in a plane behind the pick-up drums; this configuration has an extremely negative effect in regard to a balanced weight distribution of the harvester and causes an extreme load on the front axle.

U.S. Pat. No. 6,837,034 and U.S. Pat. No. 6,925,790 disclose, for example, a harvester having a centrally divided harvesting device in which the two halves can be pivoted from a working position parallel to the ground into a vertical transport position. Because of the especially advantageous use of only one cutting and pick-up device of the kind circulating about two approximately vertical axes for each half of the harvesting device, respectively, that cuts, picks up, and conveys the crop, a harvesting device is provided with simple means that, while fulfilling the aforementioned legal requirements, provides a great working width at minimal weight and minimal constructive expenditure. By avoiding an additional conveying plane, this configuration is extremely short and of a flat configuration; this greatly improves the weight distribution and the location of the center of gravity of the harvester.

The demand for even greater working widths is however limited in this configuration by the legally permissible transport height; moreover, the obstruction of the field of view caused by the halves of the harvesting device that are vertically positioned in the transport position is reduced to a minium by the intelligent arrangement of the pivot axes but is not completely avoidable.

### SUMMARY OF THE INVENTION

It is an object of the present invention to provide a self-propelled agricultural harvester of the aforementioned kind with a harvesting device that, because of its particularly advantageous configuration and light-weight construction, in its transport position no longer negatively affects driving of the harvester on roads and provides an enlarged working width of at least approximately three times the transport width.

In accordance with the present invention, this is achieved in that the crop is supplied to the intake area of the harvester exclusively within an area of the mowing and conveying means facing the upright or standing crop, wherein the mowing and conveying means of one side (half) of the harvester are driven in the same direction.

As described above, the embodiment of the harvesting attachment of the U.S. Pat. Nos. 6,837,034 and 6,925,790 has numerous advantages relative to other known configurations.

According to the present invention, it is now proposed to design a harvesting device of the advantageous configuration with a circulating mowing and conveying collector in such a way in a multi-part configuration that, for an essentially increased working width, it can be adapted to a transport width that matches the legal requirements of, for example, maximally 3 meters. Observing additional regulations with regard to maximum transport height and field of view of the driver are not only completely fulfilled by the proposed solution but, in comparison to the prior art, a significant improvement for the driver results because the harvesting device according to the present invention remains below the normal field of view of the driver even in the transport position so that in this way the field of view is improved and, in this way, the driving comfort and, in particular, traffic safety are also significantly improved.

In comparison to configurations with several mowing and conveying drums and possibly additional conveying or guiding drums, a harvesting device with only one mowing and conveying means in collector configuration for each attachment side or half requires only one drive for each harvester side, independent of the working width. When increasing the working width, only the collector length of the run changes.

These features of a collector configuration of a harvesting device, and additionally the fact that the crop is transported exclusively at the forward collector side across the entire working width so that no additional conveying plane and no additional conveying devices are required, impart to this configuration great advantages with regard to constructive design, weight, size, and thus weight distribution and, last but not least, with regard to manufacturing costs.

Because of the more than two-part configuration of a harvesting device with mowing and conveying collector, it is now necessary to provide separating locations wherein however the advantageous features of this configuration should still be utilized. According to the invention, this has been solved by arranging at least two mowing and conveying means in collector configuration at each harvester side so that between the mowing and conveying means a separating location of the harvesting device enables folding or pivoting into a transport position.

For a crop conveying action still taking place exclusively at the side facing forwardly in the working direction, the mowing and conveying means of one harvester side have the same circulating direction that transports the crop initially transversely from the exterior to the interior and briefly to the rear toward the intake area of the harvester.

The extra expenditure for the multi-part solution that is caused by additional drives, for example, is however compensated, on the other hand, in that the mowing and conveying means as a result of the shorter configuration can be designed to be more lightweight and less strong; this, in turn, allows the use of smaller deflection wheels and thus even more reduced space requirements. In particular at the separating locations of the harvesting device where the crop is to be transferred at the front side from an outer to an inner mowing and conveying means arranged closer or adjacent to the center of the harvester, a tight deflection or turn of the mowing and conveying means is very beneficial for the crop transfer.

By means of a slightly forwardly slanted orientation of the mowing and conveying means, the forward run of the collector of a mowing and conveying means that extends transversely toward the interior and cuts and picks up the crop, is closer to the ground than the neighboring rearwardly positioned empty run that moves outwardly (relative to a vertical longitudinal center plane of the harvester). As a result of the simultaneously provided arrangement of the mowing and conveying means displaced in the traveling and working direction, it is possible for the cutting and holding elements of two adjacently positioned mowing and conveying means to engage one another without colliding in the area of the separating location of the harvesting device where the crop transfer takes place.

The circulation paths (envelopes) of the cutting and holding elements overlap partially such that the crop is transferred from a farther outwardly positioned and farther forwardly positioned (in the working direction of the harvester) mowing and conveying means to a neighboring mowing and conveying means that is positioned inwardly closer or adjacent to the center of the harvesting device and, in a working direction of the harvester, farther to the rear of the harvester without subjecting the crop to a recognizable change in direction. The crop is essentially supplied linearly and transversely to the traveling and working direction along the front side of the harvesting device from the exterior to the interior (relative to a vertical longitudinal center plane of the harvester) toward the intake area of the harvester. Only when reaching this point, the crop is deflected and transported along a short path counter to the working direction but still by means of the inner mowing and conveying means toward the intake area of the harvester.

In particular the consequent linear conveying of the crop across the entire working width enables, inter alia, also an especially high conveying speed without any loss of crop as it can easily occur disadvantageously in the case of conveying drums because of centrifugal forces.

Dividing the mowing and conveying means of a half of the harvesting device into at least two mowing and conveying arrangements provides moreover advantageously an adaptation of the mowing and conveying means to the quantity of the crop that increases in the conveying direction from the exterior to the interior; for example, an adaptation is possible in regard to conveying speed or size and/or shape of the cutting and holding elements.

In an especially advantageous configuration of the harvesting device of a harvester according to the invention, the working width of the central harvesting device part, when the lateral parts are in inoperative position, is matched such to a standard row spacing of the crop that safe harvesting of a number of rows is ensured so that additional crop rows are neither damaged nor driven across by parts of the harvesting device or by the harvester itself.

Accordingly, by the special advantageous features of the invention a harvester is provided which enables a very flexibly useable harvesting device with increased working width that in the transport position does not cause any obstruction of the field of view of the driver and that significantly improves traffic safety when traveling on roads.

### BRIEF DESCRIPTION OF THE DRAWING

FIG. 1 is a perspective illustration of a self-propelled agricultural harvester according to the invention in a working and operating position showing a harvesting device divided into three parts for harvesting corn or a similar stalky crop.

FIG. 2 is a perspective illustration of the harvester according to FIG. 1 with a part of the harvesting device transferred into the transport position.

FIG. 3 is a detailed illustration of the area X of FIG. 1.

### DESCRIPTION OF THE PREFERRED EMBODIMENTS

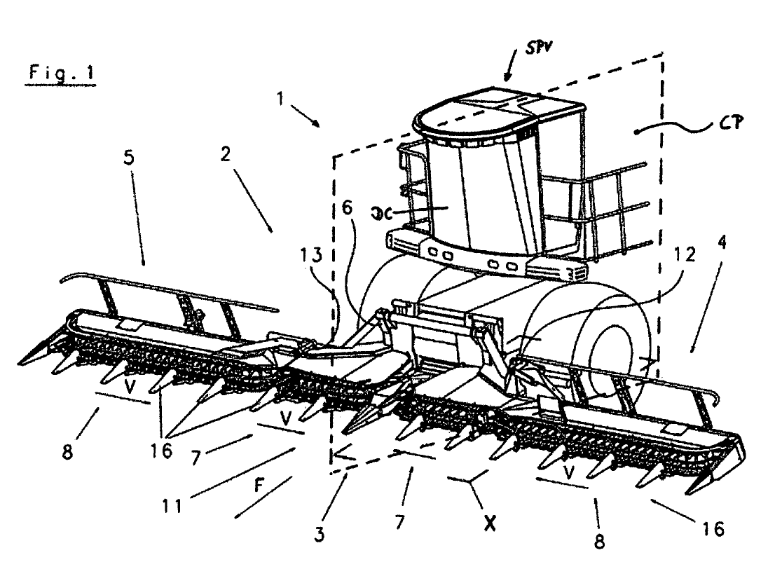

An embodiment of a self-propelled agricultural harvester 1 in the form of a field chopper with a harvesting device 2 that is used particularly as a front attachment for row-independent harvesting of stalky crop such as corn or the like is illustrated in detail in FIG. 1. The harvesting device 2 is mounted preferably to the front end of a self-propelled working vehicle SPV (of which only two front wheels and the driver's cab DC are schematically shown) and is comprised preferably, as illustrated, of three parts 3, 4, 5. The central part 3 is connected by means of a base frame 6 fixedly to the harvester. The lateral parts 4, 5 are pivotably connected to the outward edges of the central part 3 by a pivot axle 12, 13, respectively. In the working position of the harvesting device 2 illustrated in FIG. 1, the lateral parts 4, 5 are supported on the central part 3 in a way not described in detail and, if needed, are locked thereat.

The central part 3 as well as the lateral parts 4, 5 each comprise mowing and conveying means or devices 7 or 8 that are driven so as to circulate; the mowing and conveying means or devices 7 or 8 have outwardly oriented cutting and holding elements 9, 10 that cut the crop, pick up the crop, and convey the crop.

The drive action of the mowing and conveying means 7, 8 is realized by drive trains (not illustrated) connected to a power source of the harvester 1. When pivoting the lateral parts 4, 5 into an inoperative position, the drive trains of the lateral parts 4, 5 are disengaged (separated) and, in reverse, when pivoting the lateral parts 4, 5 into the working and operating position, are automatically connected (engaged).

In the illustrated embodiment, the harvesting device 2 is attached precisely centrally relative to the harvester 1 so that it extends symmetrically relative to a vertical longitudinal center plane CP of the harvester 1 on both sides. In order to be able to feed the crop supplied by the lateral parts 4, 5 simultaneously and uniformly to the intake area 11 of the harvester 1, the central part 3 of the harvesting device 2 is provided with two mowing and conveying means 7 that are driven in circulation in opposite directions (arrows V) for feeding the crop into the harvester 1.

The lateral parts 4, 5 of the harvesting device 2 of the harvester 1 according to the invention in the shown embodiment are advantageously provided with only one mowing and conveying means 8, respectively, that is driven in circulation in the direction of arrow V; during the working travel of the harvester, the mowing and conveying means 8 cut, pick up, and convey the entire crop within its reach exclusively at its front end facing in the travel direction F. The advantages of a configuration of the lateral parts 4, 5 with only a single mowing and conveying means 8 are particularly the minimal weight, the very compact size, and thus also the favorable location of the center of gravity, and the drive-technologically simple configuration. In particular in the case of continuously increasing working widths of the harvesting device, these are important criteria that affect the manufacturing costs, the handling, and the transport possibilities of the harvester in a decisive way.

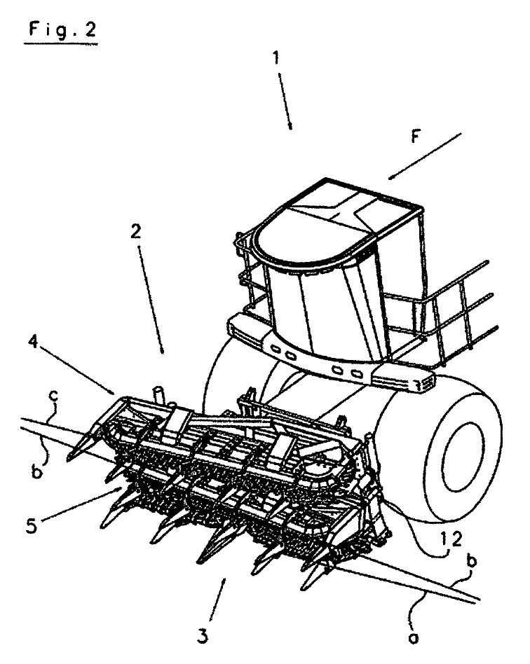

The very short configuration of the harvesting device 2 in the illustrated embodiment has advantages already in the working position illustrated in FIG. 1 with regard to short conveying travel of the crop to the intake area 11 of the harvester 1 and beneficial axle load distribution of the harvester. However, the transport position of the harvester shown in FIG. 2 illustrates additional very advantageous features.

From a working position of the harvesting device 2 according to FIG. 1, in which all parts 3, 4, 5 are positioned with their correlated mowing and conveying means 7, 8 in a plane that is at least approximately common to all parts and parallel to the ground, the transport position of the harvesting device 2 according to FIG. 2 is reached by pivoting the lateral parts 4, 5 about the pivot axles 12, 13 by means of hydraulic working cylinders (not disclosed in detail).

In this connection, the pivot axles 12, 13 that are positioned at different acute angles and additionally at different levels relative to the vertical longitudinal center plane CP of the harvester 1, enable because of their special different orientation a very compact optimized transport position of the parts 3, 4, 5 of the harvesting device 2 relative to one another. For moving the lateral parts 4, 5 into the transport position according to FIG. 2, first the lateral part 5 is pivoted about the lower pivot axle 13 by 180 degrees so that it is placed onto the center part 3 with its bottom side facing upwardly. In this connection, the slanted orientation of the pivot axle has the effect that the lateral part 5 can be stowed on the center part 3 spaced as closely as possible thereto without colliding with other components of the harvesting device 2 during the course of movement. Subsequently, the second lateral part 4 is also pivoted about 180 degrees but about the pivot axle 12 that is positioned at a significantly higher location but, for the same reasons as mentioned above, is also slantedly arranged. The higher position of the pivot axle 12 has the effect that in the transport position the lateral part 4 is stowed on the already pivoted lateral part 5 with its bottom side facing upwardly. The slightly displaced orientation of the parts 3, 4, 5 of the harvesting device 2 relative to one another in the transport position that is advantageous for the already mentioned reasons is illustrated in FIG. 2 by the lines a, b, c that are indicated as extensions of the front ends of the parts 3, 4, 5 of the harvesting device 2 only for illustration purposes.

The advantageous transport position of the harvesting device 2 of the harvester according to the invention is demonstrated particularly well in the illustration of FIG. 2. The harvesting device 2 with a working width of almost three times the width of the harvester provides in its transport position such a compact unit that, when remaining at the front end of the harvester 1 when driving on roads, it does not affect negatively the driving behavior because of its low weight and because of its center of gravity that is beneficially low and close to the harvester; moreover, the field of view of the driver is not obstructed. All this leads to a significant improvement of traffic safety.

Should such a harvesting device 2 of the illustrated embodiment be too wide in its transverse direction in the transport position for driving on roads, for example, as a result of an even further increased working width, and must therefore be transported on a separate transport vehicle, the embodiment according to the invention also has great advantages in this scenario because of its compact dimensions (size) and low center of gravity.

Because of the advantageous configuration of the harvesting device 2, the harvester 1 according to the invention can be operated also in other advantageous working modes than those illustrated in FIG. 1 and FIG. 2.

For example, it is possible to pivot one or both lateral parts 4, 5 of the harvesting device 2 by only approximately 90 degrees into a position approximately perpendicular to the ground in order to harvest either with the smallest working width, i.e., only with the central part 3, or with a medium working width, i.e., with the central part 3 and one of the lateral parts 4 or 5. Since the drive trains of the lateral parts 4, 5 are separated (disengaged) upon pivoting, the mowing and conveying means 8 in the afore described additional inoperative position are shut down. These additional working modes can be, inter alia, very advantageous when there is insufficient space available outside of the field to be harvested in order to unfold the harvesting device completely into its working position according to FIG. 1. In such a case, a corresponding area of the field can be harvested with a reduced working width without causing any loss by driving across the crop or snapping off the crop.

The advantageous features of the harvesting device 2 of the illustrated embodiment of the harvester 1 according to the invention described above are based almost exclusively on the basic principle of the mowing and conveying means 7, 8 and their configuration and use in accordance with the present invention.

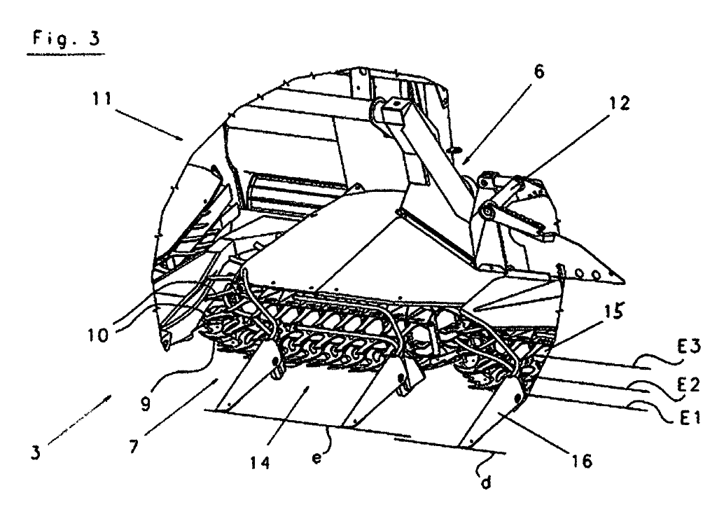

The mowing and conveying means 7, 8 comprise primarily, as can be seen in particular in the detail view of FIG. 3, pivotably connected segments 14 and cutting and holding elements 9, 10 arranged thereat. The cutting and holding elements 9, 10 point outwardly and are positioned in stacked planes E1, E2, E3. Each segment 14 has in the lower plane E1 a cutting element 9, in the central plane E2 a holding element 10, and in the upper plane E3 only a further holding element 10, respectively. The pivotably connected segments 14 of the mowing and conveying means 7, 8 are driven in circulation about at least two driving and deflecting wheels (not illustrated) such that they cut, pick up, and convey, like an endless conveyor, linearly in the direction of arrow V, the crop by means of the run positioned in front in the traveling and working direction F to the center of the harvesting device 2. A critical point of the conveying action is the interruption-free and loss-free transfer of the crop at the interface between the central part 3 and the lateral parts 4, 5. In these areas, the entire crop that has been collected and conveyed by the mowing and conveying means 8 up to this point must be transferred to the inwardly positioned mowing and conveying means 7 of the harvesting device side, respectively, and must be received by it while simultaneously additional crop must be cut and picked up.

This transfer is enabled primarily by a special arrangement of the neighboring mowing and conveying means 7, 8 of each half of the harvesting device, respectively. The spacing of the lines d and e in FIG. 3, representing parallel lines relative to the harvesting device parts 3, 4, illustrates clearly the displaced or staggered arrangement of the lateral parts 4, 5 relative to the central part 3. By means of the simultaneously provided positioning of the parts 3, 4, 5 of the harvesting device 2 at the same forward slant in such a way that the lower cutting planes E1 of the mowing and conveying means 7, 8 are spaced at the same spacing to the ground so that the crop is cut across the entire working width at the same level, overlapping of the circulating plans E1, E2, E3 of the cutting and holding elements 9,10 is enabled without causing collision.

These features and the advantageous use of segments 14 as small as possible, enabling thus deflection of the mowing and conveying means 7, 8 at small radii particularly at the transfer areas, result in fast opening and closing of the receiving spaces 15 between the holding elements 10 of the mowing and conveying means; for simultaneous overlap of the circulating planes and identical direction of circulation this results in a disruption-free transfer of the crop.

In order to assist proper function and to optimize guiding of the crop across all areas, the mowing and conveying means 7, 8 have stalk dividers 16 with guide brackets arranged thereat.

As a result of the combination of the described features of the illustrated embodiment, crop transport exclusively at the front side of the harvesting device is possible, even across interfaces of the harvesting device 2 and with transfer being required from one mowing and conveying means 8 of one lateral part 4, 5 to a mowing and conveying means 7 of the central part 3 while simultaneously additional crop can be harvested and picked up. Further embodiments with, for example, more than one foldable lateral part for each half of the harvesting device are also conceivable.

While specific embodiments of the invention have been shown and described in detail to illustrate the inventive principles, it will be understood that the invention may be embodied otherwise without departing from such principles.

What is claimed is:

1. A self-propelled agricultural harvester comprising:
a self-propelled vehicle;
a harvesting device arranged in a traveling and working direction of the harvester in front of a driver's cabin and comprising at least two parts;
wherein the harvesting device extends with a device length thereof in a transverse direction that extends transverse to the traveling and working direction;
wherein the harvesting device comprises mowing and conveying means circulatingly driven about essentially vertical axes;
wherein each side of the harvester has at least two of the mowing and conveying means positioned adjacent to one another in the transverse direction;
wherein the mowing and conveying means cut, pick up, and convey as an endless conveyor an upright crop to be harvested;
wherein the mowing and conveying means feed the crop to an intake area of the harvester exclusively with an area of the mowing and conveying means facing the upright crop to be harvested;
wherein the mowing and conveying means of each side of the harvester are driven in a same direction, respectively.

2. The harvester according to claim 1, wherein the mowing and conveying means cut, pick up, and convey the crop at a front side of the harvesting device facing in the traveling and working direction, wherein conveying of the crop takes place essentially transversely to the traveling and working direction linearly in a direction toward the center of the harvesting device.

3. The harvester according to claim 1, wherein the mowing and conveying means arranged inwardly and adjacent to a center of the harvester in the transverse direction receive the crop, harvested by the mowing and conveying means positioned outwardly in the transverse direction, by a forward end facing in the traveling and working direction and transport the crop farther toward the intake area, wherein the mowing and conveying means arranged inwardly additionally cut, pick up, and convey crop within a reach of the mowing and conveying means arranged inwardly.

4. The harvester according to claim 1, wherein the mowing and conveying means comprise outwardly oriented cutting and holding elements arranged in at least two stacked planes.

5. The harvester according to claim 4, wherein the at least two stacked planes are circulating planes of the cutting and holding elements and are slanted in the traveling and working direction.

6. The harvester according to claim 4, wherein the cutting and holding elements when circulating define an envelope and wherein the envelopes of adjacently arranged mowing and conveying means of each side of the harvesting device overlap partially, respectively.

7. The harvester according to claim 1, wherein the mowing and conveying means of each side of the harvesting device arranged adjacent to one another in the transverse direction each have a front end facing in the traveling and working direction, wherein the front ends are displaced relative to one another and are spaced at different spacings relative to the self-propelled vehicle such that the spacing of front ends of the mowing and conveying means arranged inwardly in the transverse direction is the smallest.

8. The harvester according to claim 1, wherein the mowing and conveying means of the harvester are endless conveyors extending about least two driving and deflection wheels.

9. The harvester according to claim 1, wherein the mowing and conveying means driven in circulation comprise segments that are pivotably connected to one another, wherein the segments are stacked in at least two planes above one another and have in each one of the at least two planes a cutting element or a holding element.

10. The harvester according to claim 1, wherein the harvesting device is configured to be transferred from an operating position in which the harvesting device extends transversely to the traveling and working direction into a transport position, wherein the harvester does not surpass legally permissible dimensions for traveling on roads when the harvesting device is in the transport position.

11. The harvester according to claim 1, wherein the harvesting device is configured to harvest corn or a similar stalky crop.
